(19) United States
(12) Patent Application Publication
(10) Pub. No.: US 2025/0350468 A1
(43) Pub. Date: Nov. 13, 2025

(54) UTILIZATION MANAGEMENT SYSTEM, UTILIZATION CONTROL DEVICE, MANAGEMENT DEVICE, UTILIZATION MANAGEMENT METHOD, AND PROGRAM

(71) Applicant: BITKEY INC., Tokyo (JP)

(72) Inventors: Yuki EJIRI, Tokyo (JP); Hiroshi YAMAMOTO, Tokyo (JP)

(21) Appl. No.: 18/730,207

(22) PCT Filed: Dec. 12, 2022
(86) PCT No.: PCT/JP2022/045752

§ 371 Date: Dec. 21, 2024

(30) Foreign Application Priority Data
Jan. 20, 2022 (JP) 2022-007468

(51) Int. Cl. H04L 9/32; H04L 9/08

(52) U.S. Cl. CPC H04L 9/3231; H04L 9/0861; H04L 9/321; H04L 9/3247

(57) ABSTRACT

The present invention reduces security risk while improving the convenience, and further to limit predetermined uses of a usage target object to only authorized users. When a utilization control device (1) receives a restriction on use lift request from a user terminal (4) via Near Field Communication (63), it verifies a signature included in this request with a public key set in own device (1), and when the verification is established and conditions on use of a use permit included in this request are satisfied, it lifts a first restriction on use of a vehicle (5) (door lock, key box (10) lock). Further, when the first restriction on use is released, it performs face authentication using image data including an image of the user's face in the seat imaged by a camera (2) and the face authentication information included in this request, and if the face authentication is established, it lifts a second restriction on use of the vehicle 5 (engine start lock).

### TECHNICAL FIELD

The present invention relates to a utilization management technique for managing use of a usage target object whose use can be restricted by locking/unlocking, by startup control, by access control, or by encrypting/decrypting. As such a usage target object, it is possible to mention for example a moving body such as a vehicle (an automobile, a motorcycle, a bicycle, etc.), a ship, or the like, a facility such as a hotel, an inn, a guesthouse, a house, a warehouse, or the like, or a browsing terminal for viewing an electronic medium containing for example an electronic medical record or an electronic book. In particular, the present invention can be widely used in all utilization management techniques that require confirmation of the person who has reserved a usage target object and the person who actually utilizes the reserved usage target object. Further, the present invention can be widely used in general utilization management technique that requires matching a personal certificate with a photograph (such as an ID card) with the person using a usage target object.

### BACKGROUND ART

The Patent Literature 1 discloses a system in which, by only carrying a room key, one can use various services that includes locking and unlocking of a room in a facility such as a corporate facility, a hospital, a game hall, a public facility, or the like.

This system comprises: a room keys each having a readable/writable Radio Frequency Identification (RFID) tag that stores information such as a room number, a password, customer information, or the like; RFID readers that are installed at various places of the facility for reading and writing information from and into the RFID tag of a room key; a database that stores information on rooms and equipment in the facility; and a server that is connected to the RFID readers and the database via a network and performs management of the rooms and the equipment in the facility. For example, an RFID reader installed at a door of a room or in the inside of a room reads information stored in the RFID tag of the room key and sends the information to the server. On receiving the information, the server compares the room number included in the information received from the RFID reader with the room number of the room where the RFID reader is installed, so as to lock and unlock the room in question.

### CITATION LIST

### Patent Literature

Patent Literature 1: Japanese Unexamined Patent Application Laid-Open No. 2003-132435

### SUMMARY OF INVENTION

### Technical Problem

The system described in the Patent Literature 1, however, premises that a room key is lent out and returned at a reception desk of a facility such as a corporate facility, a hospital, a game hall, a public facility, or the like. Accordingly, even if a user has reserved the facility over the Internet, the user must stop at the reception desk of the management section that manages the facility, in order to borrow the room key before moving to the reserved facility. Further, after using the facility, the user must stop again at the reception desk of the management section to return the room key. Thus, in the case where the reserved facility is geographically distant from the reception desk of the management section managing the facility, this is inconvenient.

Further, in the system of the Patent Literature 1, the RFID readers installed at various places of the facility read information stored in an RFID tag of a room key, and send the information to the server via the network. Accordingly, for example, in the case where the server is placed outside the facility and the RFID readers installed at various places inside the facility are connected to the server placed outside the facility via the Internet, read information is transmitted over the Internet each time when an RFID reader reads information from the RFID tag of a room key. Thus, the security risk is increased.

Further, the system of the Patent Literature 1 does not take into consideration a verification as to whether or not a user who uses a facility while carrying a borrowed room key is an authorized user permitted to use the facility.

The present invention has been made taking the above situation into consideration. An object of the invention is to reduce the security risk while improving the convenience, and further to limit predetermined uses of a usage target object to only authorized users, in a utilization management technique for managing use of a usage target object whose use can be restricted by locking/unlocking, by startup control, by access control, or by encrypting/decrypting, the usage target object including a moving body such as a vehicle, a ship, or the like, a facility such as a hotel, an inn, a guesthouse, a house, a warehouse, or the like, or a browsing terminal for viewing an electronic medium containing for example an electronic medical record or an electronic book.

### Solution to Problem

To solve the above problems, the present invention provides a utilization management system, comprising: a utilization control device that controls use of a usage target object by locking/unlocking, startup control, access control, or encrypting/decrypting based on a use permit; an imaging device that images a user of the usage target object; a management device that manages the usage target object in association with the utilization control device; and a user terminal that notifies the use permit to the utilization control device.

Here, the management device stores a secret key paired with a public key stored in the utilization control device, and face authentication information of the user. Further, when the usage target object is reserved by the user, the management device generates a use permit including conditions on use of the usage target object, and generates a signature for the use permit using the secret key paired with the public key stored in the utilization control device. Then, the management device sends the use permit, the face authentication information, and the signature to the user terminal.

The user terminal sends the use permit and the signature received from the management device to the utilization control device via Near Field Communication.

The utilization control device stores the public key that pairs with the secret key stored in the management device being associated with the utilization control device itself. When the utilization control device receives the use permit and the face authentication information together with the signature from the user terminal via the Near Field Communication, the utilization control device verifies the signature by using the public key owned by the utilization control device itself, and if the verification is established, the utilization control device lifts first restriction on use of the usage target object when conditions on use included in the use permit are satisfied. Further, when the first restriction on use of the usage target object is lifted, the utilization control device performs face authentication using the image data including face image of the user imaged by the imaging device and the face authentication information, and if the face authentication is established, the utilization control device lifts second restriction on use of the usage target object.

For example, the present invention provides a utilization management system for managing use of a usage target object, comprising:
a utilization control device that controls use of the usage target object by locking/unlocking, startup control, access control, or encrypting/decrypting based on a use permit including conditions on use of the usage target object;
an imaging device that images a face of a user of the usage target object and sends the image data to the utilization control device;
a management device that manages the utilization control device in association with the usage target object; and
a user terminal that communicates the use permit to the utilization control device, wherein,
the management device comprises:
a key management means that manages a secret key paired with a public key set in the utilization control device, in association with the utilization control device concerned;
a face authentication information management means that manages face authentication information of the user; and
a use permit sending means that generates a signature on the use permit by using the secret key managed by the key management means, to send the use permit, the face authentication information and the signature to the user terminal,
the user terminal comprises:
a restriction on use lift request means that sends restriction on use lift request including the use permit, the face authentication information and the signature received from the management device to the utilization control device via Near Field Communication, and
the utilization control device comprises:
a signature verification means that verifies the signature included in the restriction on use lift request received from the user terminal via the Near Field Communication, by using the public key set in the utilization control device itself;
a first restriction on use lifting means that lifts first restriction on use of the usage target object when the verification is established by the signature verification means and conditions on use included in the use permit are satisfied;
a face authentication means that performs face authentication using the image data received from the imaging device and the face authentication information included in the restriction on use lift request, when the first restriction on use of the usage target object is lifted by the first restriction on use lifting means; and
a second restriction on use lifting means that lifts second restriction on use of the usage target object, when the face authentication is established by the face authentication means.

### Advantageous Effects of Invention

In the present invention, the utilization control device obtains the use permit and the face authentication information from the user terminal using the Near Field Communication, and determines whether or not to lift restrictions on use of the usage target object by using the use permit and the face authentication information without outputting the usage permit and the face authentication information to the outside. Further, the validity of the use permit is proven by verifying the signature using the public key. Therefore, the security risk is reduced.

Further, according to the present invention, the first restriction on use of the usage target object is lifted (for example, if the usage target object is a car, unlocking a door of the car) only when the conditions on use included in the use permit are satisfied. On the other hand, when the conditions are not satisfied, the first restriction on use of the usage target object is not lifted. Accordingly, by setting the conditions on use such as a date and time of use, a number of times of use, and the like, the use permit that does not satisfy these conditions becomes invalid even though it has been authenticated. As a result, it is not necessary for the user of the usage target object (i.e., the user of the user terminal) to return the use permit. Thus, according to the present invention, convenience is improved.

Furthermore, according to the present invention, when the first restriction on use of the usage target object is lifted, the face authentication is performed using image data including a face image of the user imaged by the imaging device and the face authentication information, and if the face authentication is established, the second restriction on use of the usage target object is lifted (for example, if the usage target object is a car, unlocking an engine start of the car). For this reason, even if the validity of the use permit is proven and the conditions on use included in the use permit are satisfied, if the user of the usage target object is not a legitimate user managed by the management device, the second restriction on use of usage target object is not lifted. Therefore, the predetermined use of the usage target object (lifting of the second restriction on use) can be limited to only legitimate users.

Thus, according to the present invention, it is possible to reduce security risks while improving convenience and further to limit predetermined use of the usage target object to only legitimate users, in the utilization management technique that can restrict using of the usage target object by locking/unlocking, startup control, access control, or encrypting/decrypting.

### BRIEF DESCRIPTION OF DRAWINGS

FIG. 1 is a schematic configuration diagram showing a vehicle utilization management system according to one embodiment of the present invention;

FIG. 2 is a sequence diagram showing an example of account registration process of the user in the vehicle utilization management system of the one embodiment of the present invention;

FIG. 3 is a sequence diagram showing an example of face authentication information registration process of the user in the vehicle utilization management system of the one embodiment of the present invention;

FIG. 4 is a sequence diagram showing an example of reservation process of a vehicle 5 in the vehicle utilization management system of the one embodiment of the present invention;

FIG. 5 is a sequence diagram showing an example of restriction on use lifting process of the vehicle 5 in the vehicle utilization management system of the one embodiment of the present invention;

FIG. 6 is a sequence diagram showing an example of restriction on use lifting process of the vehicle 5 in the vehicle utilization management system of the one embodiment of the present invention and is a continuation of FIG. 5.

FIG. 7 is a schematic functional configuration diagram of a utilization control device 1;

FIG. 8 is a flowchart for explaining process of the utilization control device 1;

FIG. 9 is a flowchart for explaining process of the utilization control device 1 and is a continuation of FIG. 8;

FIG. 10 is a schematic functional configuration diagram of a user terminal 4;

FIG. 11(A) is a flowchart for explaining account registration request process of the user terminal 4, and FIG. 11(B) is a flowchart for explaining login request process of the user terminal 4;

FIG. 12(A) is a flowchart for explaining face authentication information registration request process of the user terminal 4, and FIG. 12(B) is a flowchart for explaining restriction on use lifting request process of the user terminal 4;

FIG. 13 is a flowchart for explaining reservation request process of the user terminal 4;

FIG. 14 is a schematic functional configuration diagram of a management device 3;

FIG. 15 is a diagram showing schematically an example of contents registered in a user information storage part 30;

FIG. 16 is a diagram showing schematically an example of contents registered in a utilization control device information storage part 31;

FIG. 17 is a diagram showing schematically an example of contents registered in a reservation information storage part 32;

FIG. 18(A) is a flowchart for explaining account registration request process of the management device 3, and FIG. 18(B) is a flowchart for explaining login request process of the management device 3;

FIG. 19 is a flowchart for explaining face authentication information registration request processing process of the management device 3; and

FIG. 20 is a flowchart for explaining reservation request processing process of the management device 3.

### DESCRIPTION OF EMBODIMENTS

In the following, one embodiment of the present invention will be described by taking as an example a case in which the present invention is applied to a vehicle utilization management system.

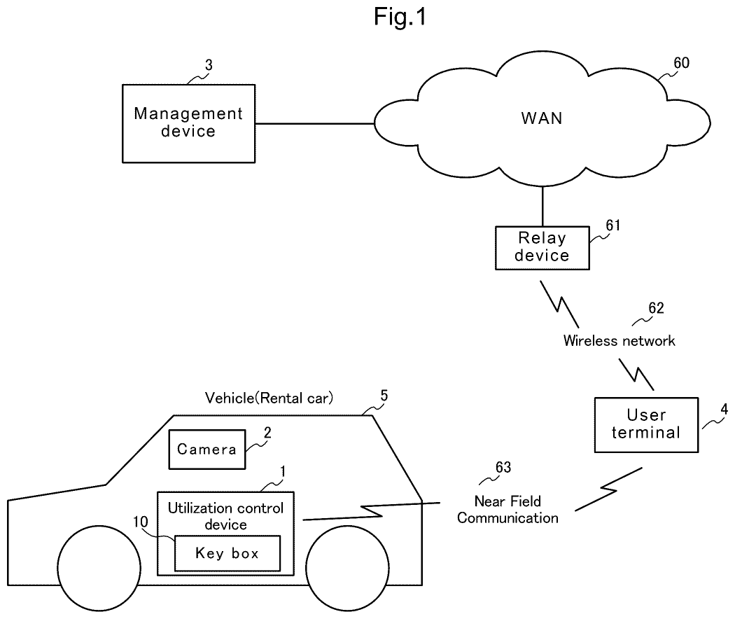

FIG. 1 is a schematic configuration diagram showing the vehicle utilization management system according to the present embodiment.

As shown in the figure, the vehicle utilization management system of the present embodiment comprises a utilization control device 1, a camera 2, a management device 3, and a user terminal 4.

The utilization control device 1 is provided for each vehicle (rental car) 5 as the usage target object, for example, in the glove box of the vehicle 5, and can communicate with the other than the vehicle 5 only via Near Field Communication 63 such as IrDA (Infrared Data Association), Bluetooth (registered trademark), or the like. The utilization control device 1 includes a key box 10 for storing a vehicle key, and controls unlocking of the key box 10 based on a use permit. Further, the utilization control device 1 is connected to an in-vehicle network (not shown) of the vehicle 5, and controls unlocking of door lock of the vehicle 5 based on the use permit, and also controls unlocking of engine start lock of the vehicle 5 based on the use permit and face authentication information.

The camera 2 is installed in a position where it can capture an image of a face of a driver seated in a driver's seat, and has a human detection sensor (not shown) such as an infrared sensor that detects the driver seated in the driver's seat. When the human detection sensor detects the driver seated in the driver's seat, the camera 2 sends image data including an image of the driver's face to the utilization control device 1.

The management device 3 manages the utilization control device 1 by associating it with the vehicle 5 in which the utilization control device 1 is installed. Further, the management device 3 manages reservation status of the vehicles 5, and when the management device 3 receives a reservation request from the user terminal 4 via a WAN (Wide Area Network) 60, the management device 3 sends the use permit and the face authentication information for using the vehicle 5 of the type included in the reservation request on the date and time included in the reservation request to the user terminal 4.

The user terminal 4 is provided for each user and connected to the WAN 60 via a wireless network 62 such as a wireless LAN (Local Area Network) and a relay device 61. Further, the user terminal 4 sends a reservation request to the management device 3 and receives the use permit and the face authentication information from the management device 3. Then, the user terminal 4 sends the use permit and the face authentication information received from the management device 3 to the utilization control device 1 via the Near Field Communication 63.

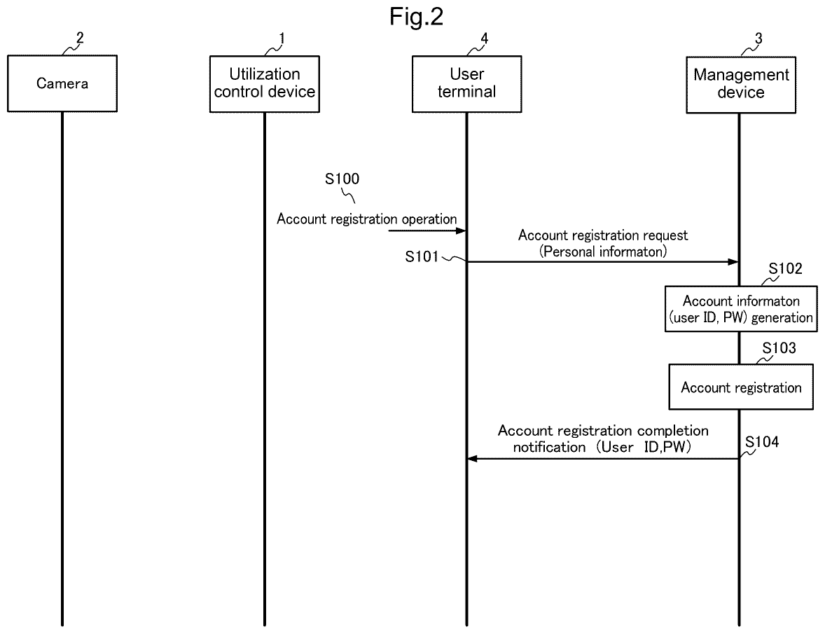

FIG. 2 is a sequence diagram showing an example of account registration process of the user in the vehicle utilization management system of the one embodiment of the present invention.

When the user terminal 4 accepts an account registration operation with personal information of the user from the user (S100), the user terminal 4 sends an account registration request including the personal information of the user to the management device 3 via the wireless network 62, the relay device 61 and the WAN 60 (S101).

In response to this, the management device 3 generates account information (user ID, password (PW)) (S102), and registers the account information in association with the personal information of the user included in the account registration request (S103). Then, the management device 3 sends an account registration completion notification including the account information to the user terminal 4 that is the sender of the account registration request, via the WAN 60, the relay device 61 and the wireless network 62 (S104).

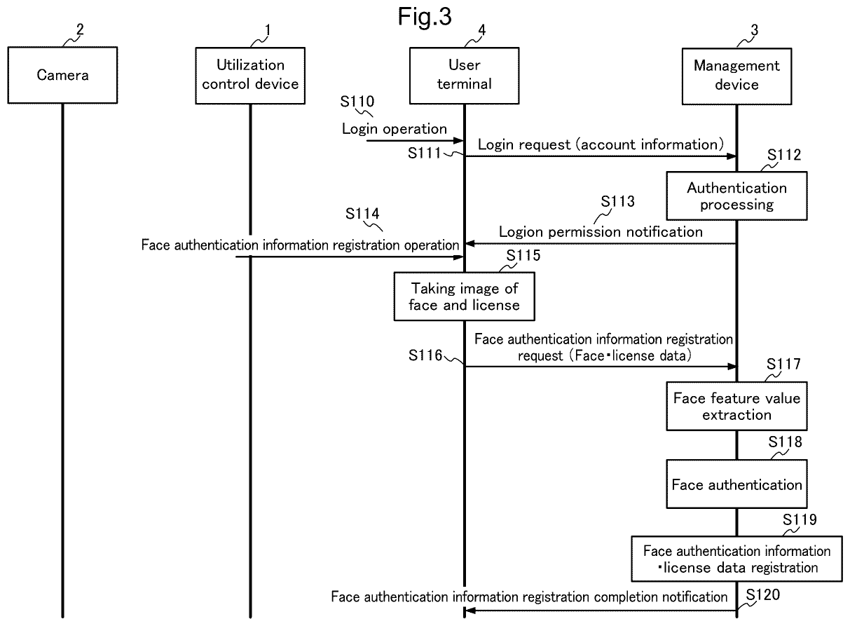

FIG. 3 is a sequence diagram showing an example of face authentication information registration process of the user in the vehicle utilization management system of the one embodiment of the present invention.

First, when the user terminal 4 accepts a login operation with account information (user ID, password) from the user (S110), the user terminal 4 sends a login request including the account information to the management device 3 (S111).

In response to this, the management device 3 performs authentication processing using the account information included in the login request and the account information registered in the management device 3 (S112). Then, if authentication is established, the management device 3 permits login of the user terminal 4 that has sent the login request, and sends a login permission notification to the user terminal 4 (S113).

Next, when the user terminal 4 accepts a face authentication information registration operation from the user (S114), the user terminal 4 images a face and a driver's license (hereinafter, license) of the user in a predetermined order using the built-in camera or an external camera of the user terminal 4 (S115). Then, the user terminal 4 sends the face authentication information registration request including the image data each of the face and the license of the user to the management device 3 (S116).

In response to this, the management device 3 extracts face feature value from both the image data of the and the image data of the license (S117). Then, the management device 3 performs face authentication of the user using the face feature value extracted from the image data of the face and the face feature value extracted from the image data of the license (S118). In particular, the degree of matching between the face feature value extracted from the image data of the face and the face feature value extracted from the image data of the license is analyzed, and if the degree of matching is equal to or greater than a predetermined value, it is determined that face authentication is established, and if the degree of matching is less than the predetermined value, it is determined that face authentication is not established. If face authentication is established, the management device 3 registers the face feature value extracted from the image data of the face or the license as the face authentication information of the user, in association with the account information of the user together with the image data of the license (S119).

Then, the management device 3 sends a face authentication information registration completion notification to the user terminal 4 that is the sender of the face authentication information registration request (S120).

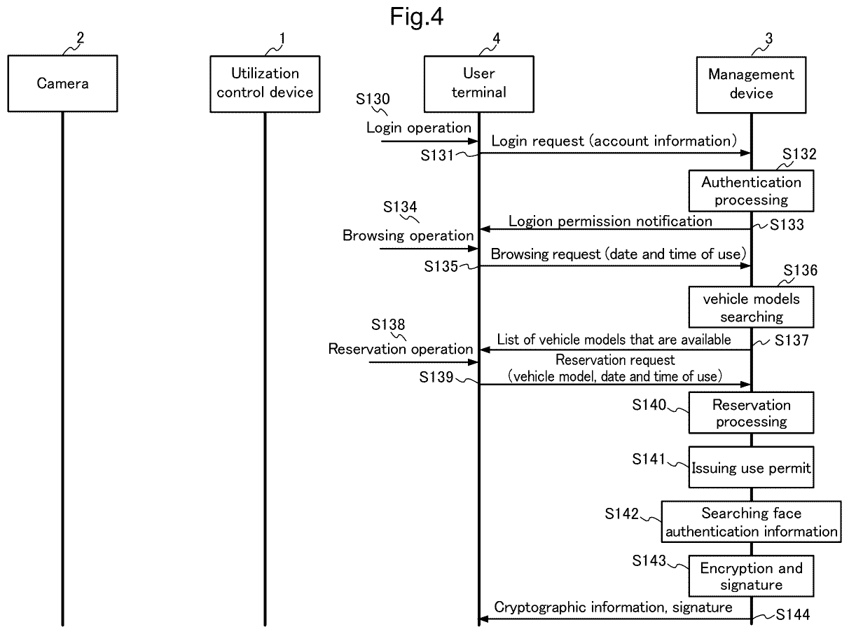

FIG. 4 is a sequence diagram showing an example of reservation process of the vehicle 5 in the vehicle utilization management system of the one embodiment of the present invention.

First, when the user terminal 4 accepts a login operation with account information (user ID, password) from the user (S130), the user terminal 4 sends a login request including the account information to the management device 3 (S131).

In response to this, the management device 3 performs authentication processing using the account information included in the login request and the account information registered in the management device 3 (S132). If the authentication is established, the management device 3 permits login of the user terminal 4 that is the sender of the login request, and sends a login permission notification to the user terminal 4 (S133).

Next, when the user terminal 4 receives a browsing operation with the date and time of use from the user (S134), the user terminal 4 sends a browsing request including the date and time of use to the management device 3 (S135).

In response to this, the management device 3 searches for vehicle models of the vehicle 5 that are available on the date and time included in the browsing request from reservation status (S136). Then the management device 3 sends a list of vehicle models that are available on the date and time to the user terminal 4 (S137).

Next, the user terminal 4 displays the list data of available vehicle models received from the management device 3 and accepts a reservation operation with selection of the vehicle model to be reserved from the user (S138). Then, the user terminal 4 sends a reservation request including the vehicle model selected by the reservation operation and the date and time of use indicated by the browsing operation to the management device 3 (S139).

In response to this, the management device 3 performs reservation processing to reserve the vehicle 5 of the vehicle model included in the reservation request for the date and time of use included in the reservation request (S140). And the management device 3 issues the use permit including the reserved date and time of use as conditions on use (S141), and searches for the face authentication information registered in association with the account information of the user (S142).

Next, the management device 3 encrypts the use permit and the face authentication information by using a common key set in the utilization control device 1 managed in association with the reserved vehicle 5 to generate cryptographic information, and generates a signature for the cryptographic information using a secret key paired with a public key set in the utilization control device 1 (S143). Then, the management device 3 sends the cryptographic information and the signature to the user terminal 4 (S144).

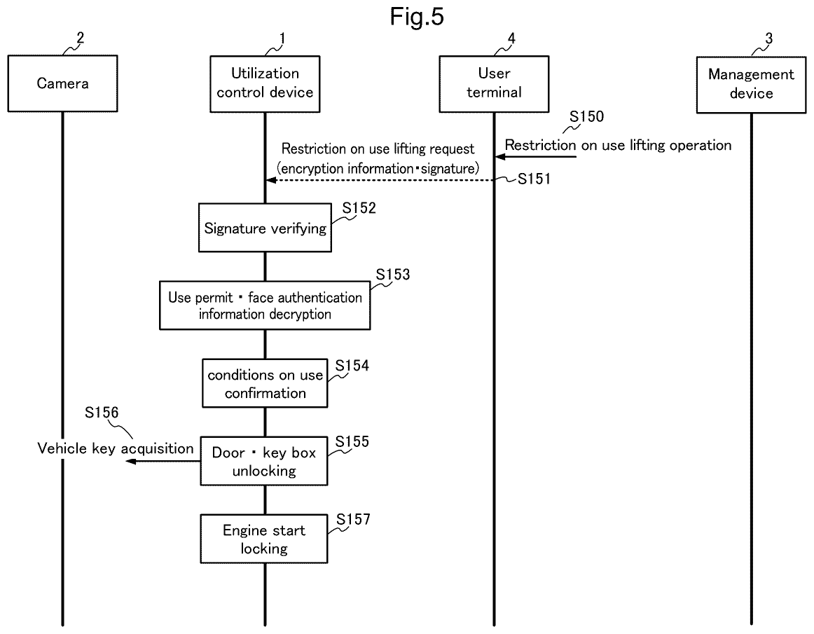

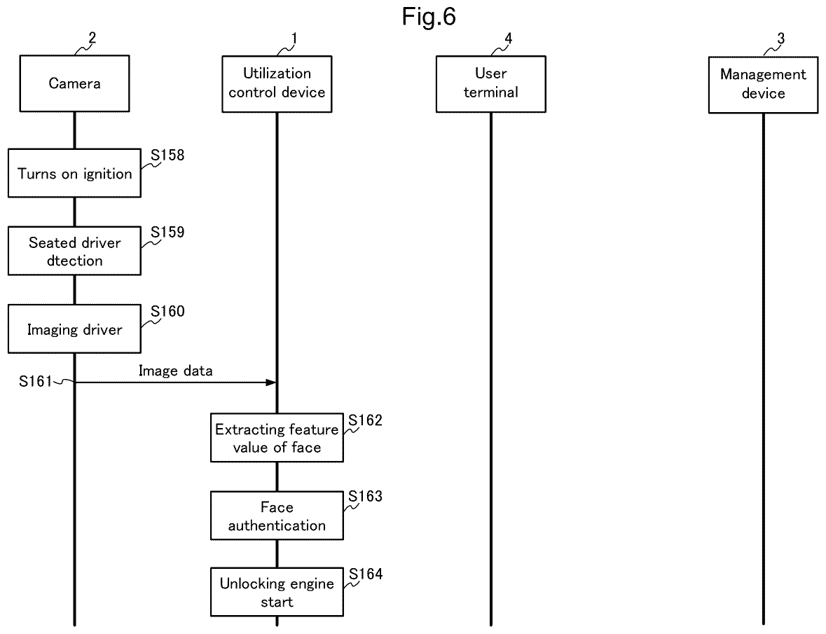

FIG. 5 and FIG. 6 are a sequence diagram showing an example of restriction on use lifting process of the vehicle 5 in the vehicle utilization management system of the one embodiment of the present invention.

It is assumed that the user, carrying the user terminal 4, moves close to the vehicle 5 reserved. Here, when the user terminal 4 accepts a restriction on use lifting operation from the user (S150), the user terminal 4 sends a restriction on use lifting request including the encryption information and the signature received from the management device 3 for the vehicle 5 reserved via the Near Field Communication 63 to the utilization control device 1 (S151).

In response, the utilization control device 1 verifies the signature for the cryptographic information, the signature being included together with the cryptographic information in the restriction on use lifting request received from the management device 3, by using the public key set in own device 1 (S152). If the signature verification is established, the utilization control device 1 decrypts the cryptographic information included in the restriction on use lifting request into the use permit and the face authentication information by using the common key set to own device 1 (S153).

Then, the utilization control device 1 checks whether the conditions on use included in the use permit are satisfied (S154). In particular, the utilization control device 1 confirms that the current date and time belongs to the time period (the time period from the start date and time of use to the end date and time of use) of the date and time of use included in the use permit as conditions on use. If it is confirmed that the conditions on use are satisfied, the utilization control device 1 unlocks the door of the vehicle 5 and also the key box 10 (S155). This allows the user to open the door of the vehicle 5, get inside the vehicle 5, and obtain the vehicle key from the key box 10 (S156).

In addition, the utilization control device 1 locks the engine start of the vehicle 5 (S157). Therefore, at this timing, the ignition of the vehicle 5 can be turned on using the vehicle key, but the engine of the vehicle 5 cannot be started unless the engine start lock is released.

Next, it is assumed that the user sits in the driver's seat of the vehicle 5 as the driver and turns on the ignition of the vehicle 5 using the vehicle key. By this, the power to the camera 2 is turned on, and camera 2 starts up (S158). The camera 2 monitors the presence or absence of the driver seated in the driver's seat by using the human detection sensor, and when the camera 2 detects that the driver is seated in the driver's seat based on the output of the human detection sensor (S159), the camera 2 images or captures the driver (S160) and send the image data including the face image of the driver to the utilization control device 1 (S161).

When the utilization control device 1 receives the image data from the camera 2, the utilization control device 1 extracts the feature value of the driver's face included in the image data (S162). Then, the utilization control device 1 performs face authentication of the driver by using the feature value of the driver's face extracted from the image data of the camera 2 and the face authentication information included in the restriction on use lifting request received from the user terminal 4 (S163). In particular, the utilization control device 1 analyzes the degree of matching between the feature value of the driver's face extracted from the image data and the face authentication information, and if the degree of matching is equal to or greater than a predetermined value, the utilization control device 1 determines that face authentication is established, and if the degree of matching is less than the predetermined value, the utilization control device 1 determines that face authentication is not established.

If face authentication is established, the utilization control device 1 unlocks the engine start of the vehicle 5 (S164). By this, if the driver is the user of the user terminal 4 who has made the reservation for the vehicle 5 (the person reserving the vehicle 5), the driver can start the engine using the vehicle key and drive the vehicle 5. On the other hand, a user (such as a passenger) other than the person who reserved the vehicle 5 can borrow the user terminal 4 or the vehicle key from the person who reserved the vehicle 5 and get into the vehicle 5, but cannot start the engine of the vehicle 5.

Next, the utilization control device 1, the user terminal 4, and the management device 3 as the components of the utilization management system of the present embodiment will be described in detail. On the other hand, an existing camera with a human detection sensor can be used as the camera 2, and thus detailed description of the camera 2 is omitted.

First, the utilization control device 1 will be described in detail.

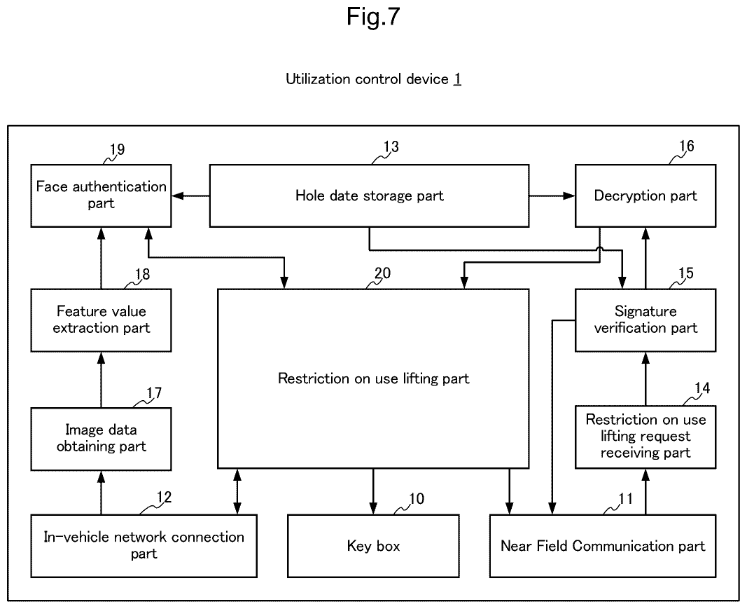

FIG. 7 is a schematic functional configuration diagram of the utilization control device 1.

As shown in the figure, the utilization control device 1 comprises a key box 10, a Near Field Communication part 11, an in-vehicle network connection part 12, a hole date storage part 13, a restriction on use lifting request receiving part 14, a signature verification part 15, a decryption part 16, an image data obtaining part 17, a feature value extraction part 18, face authentication part 19, and a restriction on use lifting part 20.

The key box 10 is a storage box for the vehicle key and has an auto-lock function.

The Near Field Communication part 11 communicates with the user terminal 4 via the Near Field Communication 63 such as IrDA, Bluetooth (registered trademark), or the like.

The in-vehicle network connection part 12 is an interface for connecting to an in-vehicle network (not shown) of the vehicle 5.

The hole data storage part 13 stores hole data including the public key (the public key paired with the secret key assigned to the utilization control device 1) and the common key (the common key held secretly between the utilization control device and the management device 3).

The restriction on use lifting request receiving part 14 receives the restriction on use lifting request including the cryptographic information both of the use permit and the face authentication information, and the signature for the cryptographic information from the user terminal 4 via the Near Field Communication part 11.

The signature verification part 15 verifies the signature included in the restriction on use lifting request received by the restriction on use lifting request receiving part 14 by using the public key included in the hole data stored in the hole data storage part 13.

The decryption part 16 decrypts the cryptographic information included in the restriction on use lifting request received by the restriction on use lifting request receiving part 14 into the use permit and the face authentication information by using the common key included in the hole data stored in the hole data storage part 13.

The image data obtaining part 17 obtains the image data including an image of the driver's face from the camera 2 via the in-vehicle network connection part 12.

The feature value extraction part 18 extracts feature value of the driver's face from the image data of the driver obtained by the image data obtaining part 17.

The face authentication part 19 performs face authentication by using the feature value of the driver's face extracted by the feature value extraction part 18 and the face authentication information decrypted by the decryption part 16. In particular, the face authentication part 19 analyzes the degree of matching between the feature value of the driver's face and the face authentication information, and determines that face authentication is established if the degree of matching is equal to or greater than a predetermined value, and that face authentication is not established if the degree of matching is less than the predetermined value.

The restriction on use lifting part 20 unlocks the key box 10 and sends a door unlock command and an engine start lock command to the vehicle 5 via the in-vehicle network connection part 12 when the signature verification by the signature verification part 15 is established and the conditions on use included in the use permit decrypted by the decryption part 16 are satisfied. And when the key box 10 and the door are unlocked and the engine start is locked, if face authentication is established by the face authentication part 19, the restriction on use lifting part 20 sends an engine start unlock command to the vehicle 5 via the in-vehicle network connection part 12.

Here, the schematic functional configuration of the utilization control device 1 shown in FIG. 7 may be implemented by hardware, for example by using an integrated logic IC such as an Application Specific Integrated Circuit (ASIC), a Field Programmable Gate Array (FPGA), or the like, or may be implemented by software on a computer device such as a Digital Signal Processor (DSP), or the like. Or in a general-purpose computer comprising a CPU, a memory, an auxiliary storage such as a flash memory, and a Near Field Communication device such as an IrDA communication device, a Bluetooth (registered trademark) communication device, or the like, the schematic functional configuration may be implemented by the CPU loading a prescribed program from the auxiliary storage into the memory and executes the program.

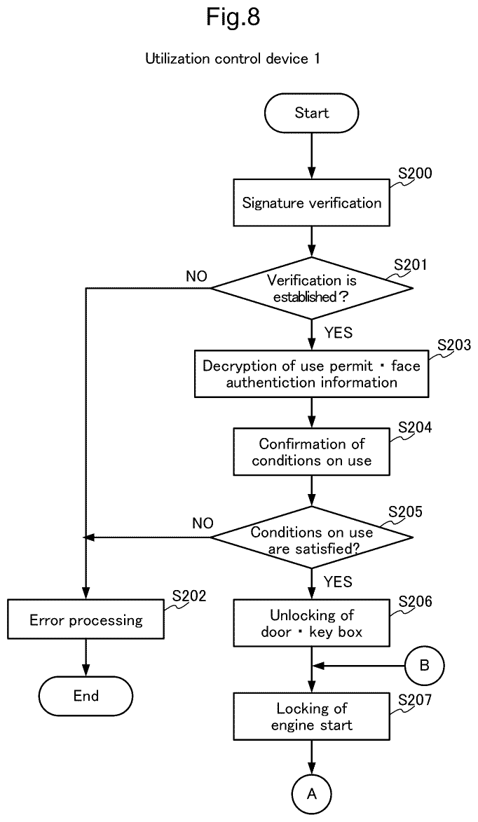

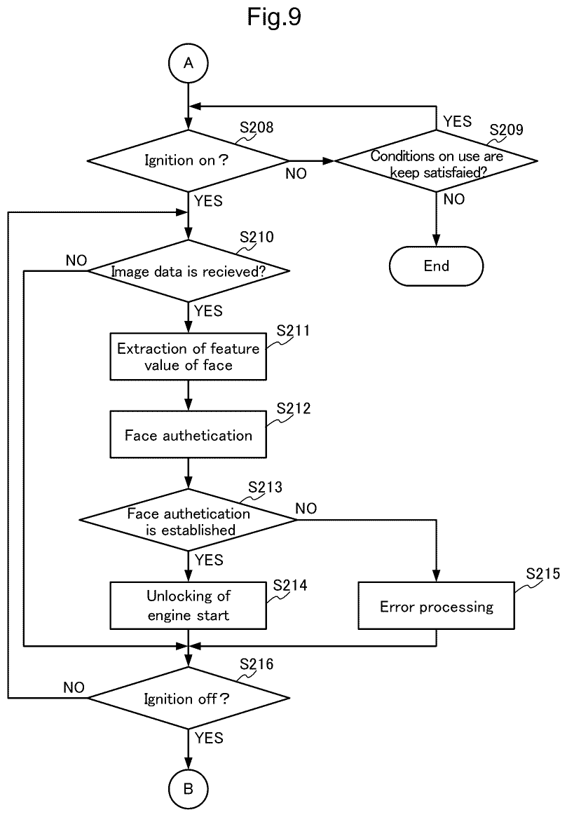

FIG. 8 and FIG. 9 are a flowchart for explaining process of the utilization control device 1.

This flow is started when the restriction on use lifting request receiving part 14 receives the restriction on use lifting request from the user terminal 4 via the Near Field Communication part 11.

First, the restriction on use lifting request receiving part 14 passes the cryptographic information and the signature included in the restriction on use lifting request received from the user terminal 4 to the signature verification part 15. In response to this, the signature verification part 15 verifies the signature for the cryptographic information by using the public key included in the hole data stored in the hole data storage part 13 (S200). In particular, the signature verification part 15 decrypts the signature by using the public key, and verifies the authenticity of the signature by determining whether the decrypted information matches the cryptographic information or its message digest (hash value).

If the signature verification is not established (NO in S201), the signature verification part 15 performs a predetermined error processing such as notifying the user terminal 4 of the failure via the Near Field Communication part 11 (S202), and ends this flow.

On the other hand, if the signature verification is established (YES in S201), the signature verification part 15 passes the cryptographic information to the decryption part 16. In response to this, the decryption part 16 decrypts the cryptographic information received from the signature verification part 15 into the use permit and the face authentication information by using the common key included in the hole data stored in the hole data storage part 13 (S203). Then, the decryption part 16 passes the use permit and the face authentication information to the restriction on use lifting part 20.

Next, the restriction on use lifting part 20 confirms whether or not the conditions on use included in the use permit received from the decryption part 16 are satisfied (S204). For example, it is confirmed whether the current date and time belongs to the time period of the date and time of use (the time period from the start date and time of use to the end date and time of use) included in the use permit as the conditions on use. If the conditions on use are not satisfied (NO in S205), the restriction on use lifting part 20 performs a predetermined error processing such as notifying the user terminal 4 of this fact via the Near Field Communication part 11 (S202), and ends this flow.

On the other hand, if the conditions on use are satisfied (YES in S205), the restriction on use lifting part 20 sends the door unlock command to the vehicle 5 via the in-vehicle network connection part 12 to cause the vehicle 5 to unlock the door and also unlock the key box 10 (S206). This allows the user of the user terminal 4 to open the door of the vehicle 5, get into the vehicle 5, and obtain the vehicle key from the key box 10. Then, the restriction on use lifting part 20 sends the engine start lock command to the vehicle 5 via the in-vehicle network connection part 12 to lock the engine start of the vehicle 5 (S207). Therefore, at this time, the ignition of the vehicle 5 can be turned on by using the vehicle key, but the engine cannot be started unless the engine start lock is released.

Next, the restriction on use lifting part 20 monitors the ignition state of the vehicle 5 via the in-vehicle network connection part 12 and confirms whether the conditions on use are keep satisfied. In the ignition-off state (NO in S208), if the conditions on use are no longer satisfied (NO in S209), the restriction on use lifting part 20 ends this flow. On the other hand, in the ignition-on state (YES in S208), the restriction on use lifting part 20 waits for the face authentication result to be sent from the face authentication part 19.

Next, in the ignition-on state (YES in S208), when the image data obtaining part 17 receives image data from the camera 2 via the in-vehicle network connection part 12 (YES in S210), the image data obtaining part 17 passes the image data to the feature value extraction part 18. In response to this, the feature value extraction part 18 extracts the feature value of the driver's face from the image data received from the image data obtaining part 17 (S211) and passes them to the face authentication part 19. Then, the face authentication part 19 obtains the face authentication information decrypted by the decryption part 16 from the restriction on use lifting part 20, and performs the face authentication by using this face authentication information and the feature value of the driver's face received from the feature value extraction part 18 (S212), and passes its face authentication result to the restriction on use lifting part 20.

When the restriction on use lifting part 20 receives the face authentication result from the face authentication part 19, if the face authentication result indicates that face authentication is established (YES in S213), the restriction on use lifting part 20 sends the engine start unlock command to the vehicle 5 via the in-vehicle network connection part 12, causing the vehicle 5 to unlock the engine start (S214). As a result, the user of the user terminal 4 who has made the reservation for the vehicle 5 (the person reserving the vehicle 5) can start the engine using the vehicle key and drive the vehicle 5 as a driver.

On the other hand, if the face authentication result received from the face authentication part 19 indicates that face authentication is not established (NO in S213), the restriction on use lifting part 20 performs a predetermined error processing, such as outputting an error message to the vehicle 5 via the in-vehicle network connection unit 12, without unlocking the engine start (S215). For this reason, the user (such as the passenger) other than the person who reserved the vehicle 5 cannot start the engine of the vehicle 5 even if the user borrows the user terminal 4 or the vehicle key from the person who reserved the vehicle 5 and gets into the vehicle 5.

Further, if the ignition of the vehicle 5 is changed from the ignition-on state to the ignition-off state (YES in S216), the restriction on use lifting part 20 returns to S207 and locks the engine start of the vehicle 5.

Next, the user terminal 4 will be described in detail.

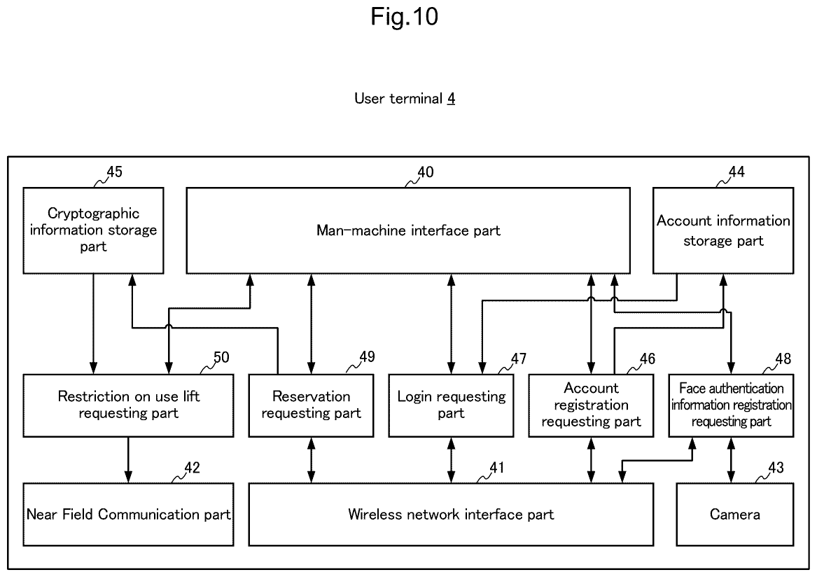

FIG. 10 is a schematic functional configuration diagram of the user terminal 4.

As shown in the figure, the user terminal 4 comprises a man-machine interface part 40, a wireless network interface part 41, a Near Field Communication part 42, a built-in or external camera 43, an account information storage part 44, a cryptographic information storage part 45, an account registration requesting part 46, a login requesting part 47, a face authentication information registration requesting part 48, a reservation requesting part 49, and a restriction on use lift requesting part 50.

The man-machine interface part 40 is an interface for presenting information to the user and accepting various operations from the user, and has for example a touch panel display.

The wireless network interface part 41 is an interface for connecting with the WAN 60 via the wireless network 62 and the relay device 61.

The Near Field Communication part 42 communicates with the utilization control device 1 via the Near Field Communication 63 such as IrDA, Bluetooth (registered trademark), or the like.

The account information storage unit 44 stores account information (user ID, password) for the user terminal 4 to login to the management device 3.

The cryptographic information storage part 45 stores the cryptographic information of the use permit and the face authentication information, and the signature for the encryption information.

The account registration request part 46 sends the account registration request to the management device 3 in accordance with the account registration operation accepted from the user via the man-machine interface unit 40, obtains the account information from the management device 3, and stores it in the account information storage unit 44.

The login requesting part 47 sends the login request containing the login information stored in the account information storage unit 44 to the management device 3, according to the login operation accepted from the user via the man-machine interface part 40, in order to login to the management device 3.

The face authentication information registration request part 48 causes the camera 43 to image the face and the license of the user of the user terminal 4, and sends the face authentication information registration request including the image data of them to the management device 3, to register the face authentication information of the user of the user terminal 4 in the management device 3, in accordance with the facial authentication information registration operation received from the user via the man-machine interface part 40.

The reservation request part 49 obtains the list data of vehicle models of the vehicle 5 that are available on the user's desired date and time from the management device 3 in accordance with the browsing operation accepted from the user via the man-machine interface part 40, and displays it on the man-machine interface part 40. Further, when the reservation request part 49 accepts the reservation operation from the user via the man-machine interface part 40 to select one of the vehicle models of the vehicle 5 listed on the man-machine interface part 40, the reservation request part 49 sends the reservation request including the vehicle model and the user's desired date and time of use to the management device 3. This allows the reservation request part 49 to obtain the cryptographic information both of the use permit and the face authentication information required to use the desired model of vehicle 5 on the desired date and time of use, as well as the signature for this cryptographic information, from the management device 3 and stored them in the cryptographic information storage part 45.

The restriction on use lifting request part 50 sends the restriction on use lifting request, including the cryptographic information and the signature stored in the cryptographic information storage part 45, to the utilization control device 1 via the Near Field communication part 42 in accordance with the restriction on use lifting operation accepted from the user via the man-machine interface part 40.

The schematic functional configuration of the user terminal 4 shown in FIG. 10 may be implemented by hardware, for example by using an integrated logic IC such as an ASIC, an FPGA, or the like, or may be implemented by software on a computer device such as a DSP. Or in a network terminal such as a smartphone, a tablet PC, or the like, comprising a CPU, a memory, an auxiliary storage such as a flash memory, a Near Field Communication device such as an IrDA communication device, a Bluetooth (registered trademark) communication device, a wireless network communication device such as a wireless LAN adapter, and a camera, the schematic functional configuration may be implemented by the CPU loading a prescribed program into the memory from the auxiliary storage and executes the program.

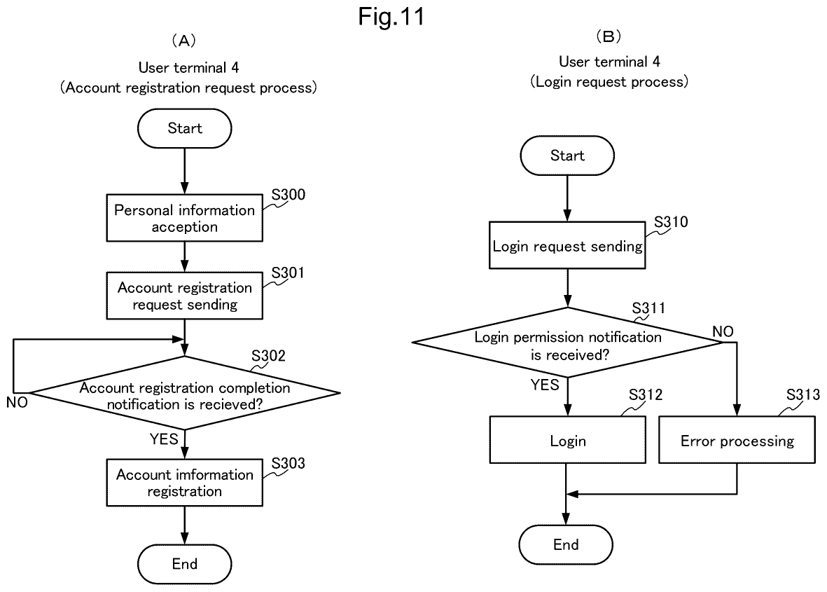

FIG. 11(A) is a flowchart for explaining account registration request process of the user terminal 4.

This flow starts when the account registration requesting part 46 accepts the account registration operation from the user via the man-machine interface part 40.

First, the account registration requesting part 46 accepts personal information (name, address, contact details, etc.) from the user via the man-machine interface part 40 (S300). Then, the account registration requesting part 46 sends the account registration request including the personal information accepted from the user to the management device 3 via the wireless network interface part 41 (S301).

Next, when the account registration requesting part 46 receives the account registration completion notification from the management device 3 via the wireless network interface part 41 (YES in S302), the account registration requesting part 46 stores the account information (user ID, password) included in the account registration completion notification in the account information storage part 44 (S303).

FIG. 11(B) is a flowchart for explaining login request process of the user terminal 4.

This flow starts when the login requesting part 47 accepts the login operation from the user via the man-machine interface part 40 after the account information has been registered.

First, the login requesting part 47 reads the account information from the account information storage part 44, and sends the login request including this account information to the management device 3 via the wireless network interface part 41 (S310).

Next, when the login requesting part 47 receives the login permission notification from the management device 3 via the wireless network interface part 41 (YES in S311), the login requesting part 47 sets the login status of the user terminal 4 to the management device 3 to “logged in” (S312). On the other hand, when the login requesting part 47 receives a login rejection notification from the management device 3 via the wireless network interface part 41 (NO in S311), the login requesting part 47 performs a predetermined error processing, such as displaying an error message on the man-machine interface part 40 to the effect that login to the management device 3 has been rejected, and leaves the login status of the user terminal 4 to the management device 3 as “logged out” (S313).

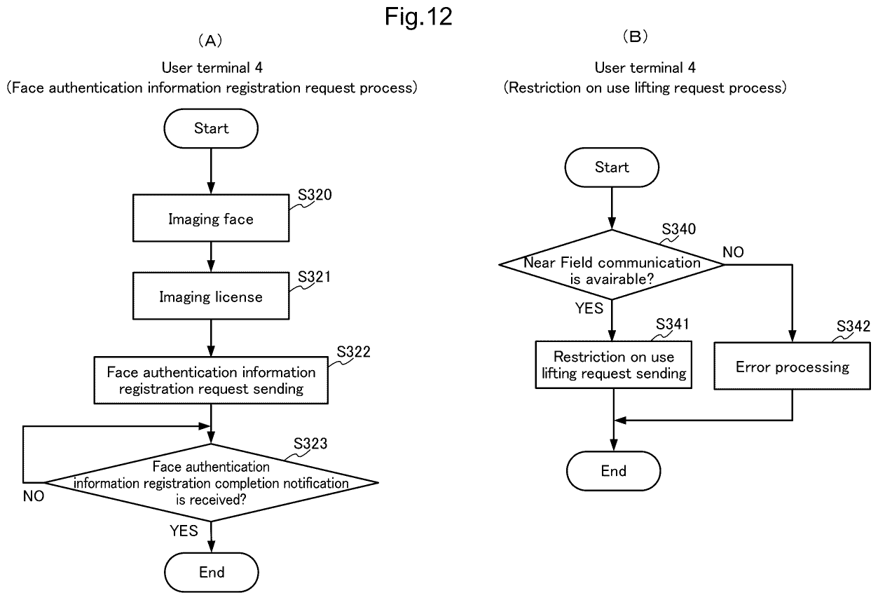

FIG. 12(A) is a flowchart for explaining face authentication information registration request process of the user terminal 4.

This flow is started when the face authentication information registration requesting part 48 accepts the face authentication information registration operation from the user via the man-machine interface part 40 while the user terminal 4 is logged in to the management device 3.

First, the face authentication information registration requesting part 48 outputs guidance for causing the camera 43 to image the user's face from the man-machine interface part 40, and causes the camera 43 to image the user's face (S320). Then, the face authentication information registration requesting part 48 outputs guidance for causing the camera 43 to image the license of the user from the man-machine interface part 40, and causes the camera 43 to image the license of the user (S321). The user's face and license may be imaged in the reverse order of above imaging order, or may be imaged simultaneously.

Next, the face authentication information registration requesting part 48 sends the face authentication information registration request including image data both of the user's face and license to the management device 3 via the wireless network interface part 41 (S322). Then, the face authentication information registration requesting part 48 receives the face authentication information registration completion notification from the management device 3 (YES in S323), and ends this flow.

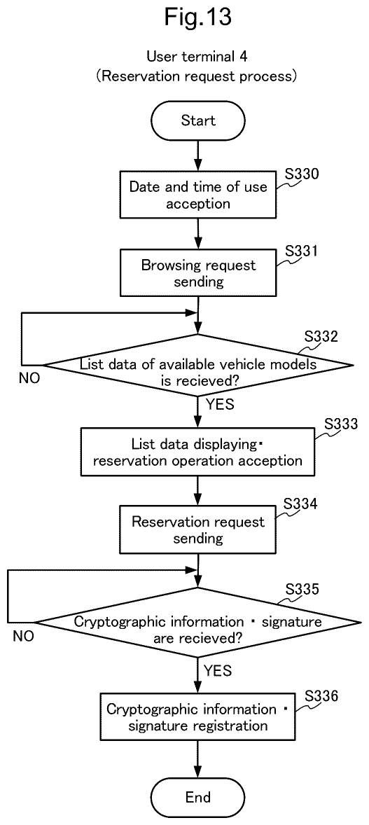

FIG. 13 is a flowchart for explaining reservation request process of the user terminal 4.

This flow is started when the reservation requesting part 49 accepts the browsing operation from the user via the man-machine interface part 40 while the user terminal 4 is logged in to the management device 3 after the face authentication information is registered.

First, the reservation requesting part 49 accepts desired date and time of use of the vehicle 5 (start date and time of use and end date and time of use) from the user via the man-machine interface part 40 (S330). Then, the reservation requesting part 49 sends the browsing request including the date and time of use accepted from the user to the management device 3 via the wireless network interface part 41 (S331).

Next, when the reservation requesting part 49 receives the list data of available vehicle models from the management device 3 via the wireless network interface part 41 (YES in S332), the reservation requesting part 49 displays this list data of available vehicle models on the man-machine interface part 40 and accepts the reservation operation including selection of the vehicle model to be reserved from the user (S333) Then, the reservation requesting part 49 sends the reservation request including the selected vehicle type and the date and time of use to the management device 3 via the wireless network interface part 41 (S334).

Next, when the reservation requesting part 49 receives the cryptographic information and the signature from the management device 3 via the wireless network interface part 41 along with guidance information including the vehicle number and storage location of the reserved vehicle 5 (YES in S335), the reservation requesting part 49 outputs the guidance information from the man-machine interface part 40 and stores the cryptographic information and the signature in the cryptographic information storage part 45 (S336).

FIG. 12(B) is a flowchart for explaining restriction on use lifting request process of the user terminal 4.

This flow is started when the restriction on use lift requesting part 50 accepts the restriction on use lifting operation from the user via the man-machine interface part 40.

First, the restriction on use lift requesting part 50 confirms whether the Near Field communication part 42 is capable of communicating with the nearest utilization control device 1 via the Near Field communication 63 (S340).

If communication with the nearest utilization control device 1 is possible via the Near Field communication 63 (YES in S340), the restriction on use lift requesting part 50 reads out the cryptographic information and the signature stored in the cryptographic information storage part 45, and sends the restriction on use lifting request including them from the Near Field communication part 42 to the utilization control device 1 via the Near Field communication 63 (S341).

On the other hand, if communication with the nearest utilization control device 1 via the Near Field communication 63 is not possible (NO in S340), the restriction on use lifting request part 50 performs a predetermined error processing, such as displaying a message on the man-machine interface part prompting the user to perform the restriction on use lifting operation near the reserved vehicle 5 (S342).

Next, the management device 3 will be described in detail.

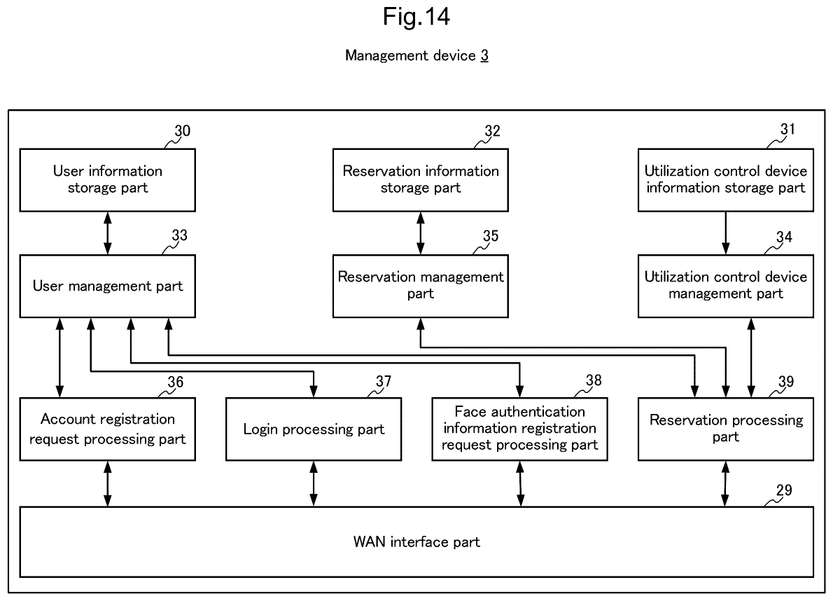

FIG. 14 is a schematic functional configuration diagram of the management device 3.

As shown in the figure, the management device 3 comprises a WAN interface part 29, a user information storage part 30, a utilization control device information storage part 31, a reservation information storage part 32, a user management part 33, a utilization control device management part 34, reservation management part 35, an account registration request processing part 36, a login processing part 37, a face authentication information registration request processing part 38, and a reservation processing part 39.

The WAN interface part 29 is an interface for connecting with the WAN 60.

The user information storage part 30 stores the user information including the account information and the face authentication information for each user.

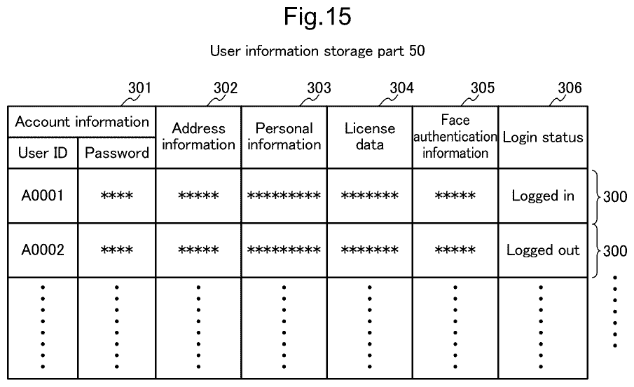

FIG. 15 is a diagram showing schematically an example of contents registered in the user information storage part 30.

As shown in the figure, a user information record 300 is stored for each user in the user information storage part 30. The user information record 300 has a field 301 in which account information including the user ID and the password of the user is registered, a field 302 in which address information on the WAN 60 of the user terminal 4 is registered, a field 303 in which personal information such as the user's name, address, and contact information is registered, a field 304 in which the license data of the user is registered, a field 305 in which the face authentication information of the user is registered, and a field 306 in which the login status (logged in or logged out) of the user is registered.

The utilization control device information storage part 31 stores, for each utilization control device 1, utilization control device information including the hall data set in the utilization control device 1 and the vehicle number of the vehicle 5 in which the utilization control device 1 is installed.

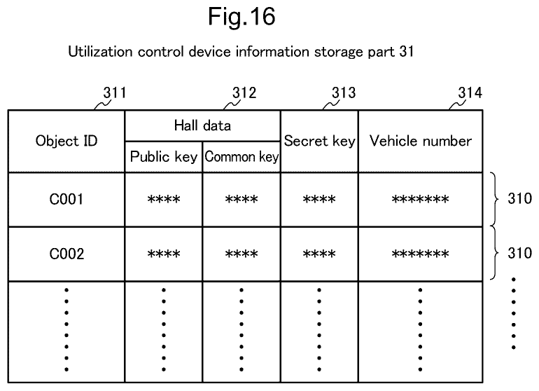

FIG. 16 is a diagram showing schematically an example of contents registered in the utilization control device information storage part 31.

As shown in the figure, the utilization control device information storage part 31 stores a utilization control device information record 310 for each utilization control device 1. The utilization control device information record 310 has a field 311 in which an object ID as identification information of the utilization control device 1 is registered, a field 312 in which hall data including the public key and the common key set in the utilization control device 1 is registered, a field 313 in which the secret key paired with the public key set in the utilization control device 1 is registered, and a field 314 in which the vehicle number of the vehicle 5 in which the utilization control device 1 is installed is registered.

The reservation information storage part 32 stores the reservation information for each vehicle 5 in association with the vehicle information including the vehicle number, vehicle model, and storage location of the vehicle 5.

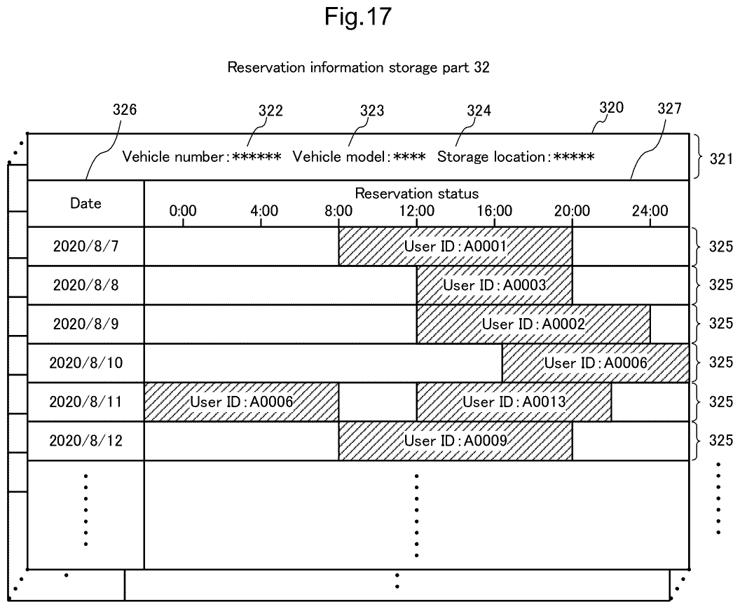

FIG. 17 is a diagram showing schematically an example of contents registered in the reservation information storage part 32.

As shown in the figure, the reservation information storage part 32 stores, for each vehicle 5, a reservation information table 320 for the vehicle 5 in association with vehicle information 321 including a vehicle number 322, a vehicle model 323, and a storage location 324 of the vehicle 5. The reservation information table 320 stores, for each date 326, a record 325 indicating a reservation status 327 for that day.

The user management part 33 manages the user in association with the user terminal 4 possessed by the user, by using the user information storage part 30.

The utilization control device management part 34 manages the utilization control device 1 in association with the vehicle 5 in which the utilization control device 1 is installed, by using the utilization control device information storage part 31.

The reservation management part 35 manages the reservation status of the vehicle 5 by using the reservation information storage part 32.

The account registration request processing part 36 cooperates with the user management part 33 to process the account registration request received from the user terminal 4.

The login processing part 37 cooperates with the user management part 33 to process the login request received from the user terminal 4.

The face authentication information registration request processing part 38 cooperates with the user management part 33 to process the face authentication information registration request received from the user terminal 4.

And the reservation processing part 39 cooperates with the reservation management part 35 to process the browsing request and the reservation request received from the user terminal 4.

The schematic functional configuration of the management device 3 shown in FIG. 14 may be implemented by hardware, for example by using an integrated logic IC such as an ASIC, an FPGA, or the like, or by software on a computer device such as a DSP. Or in a general-purpose computer comprising a CPU, a memory, an auxiliary storage such as a flash memory or a hard disk drive, and a communication device such as a Network Interface Card (NIC), or the like, the schematic functional configuration may be implemented as processes by the CPU loading a prescribed program from the auxiliary storage into the memory and executes the program. Further, the schematic functional configuration may be implemented on a distributed system comprising a plurality of general-purpose computers that cooperate with one another. For example, the user information storage part 30, the user management part 33, the account registration request processing part 36, the login processing part 37, and the face authentication information registration request processing part 38 (functional configurations responsible for the account registration process shown in FIG. 2, and the login process and the face authentication information registration process shown in FIG. 3), and the utilization control device information storage part 31, the reservation information storage part 32, the utilization control device management part 34, the reservation management part 35, and the reservation processing part 39 (functional configurations responsible for the reservation process shown in FIG. 4 (excluding login process S132, S133)) may each be realized on a separate computer.

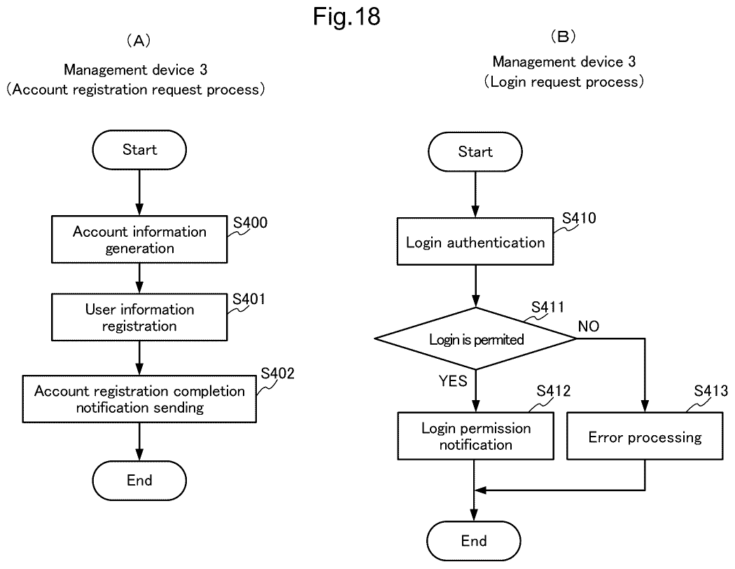

FIG. 18(A) is a flowchart for explaining account registration request process of the management device 3.

This flow is started when the account registration request processing part 36 receives the account registration request from the user terminal 4 via the WAN interface part 29.

First, the account registration request processing part 36 generates the account information (user ID, password) (S400), and passes this account information and the personal information included in the account registration request to the user management part 33 together with the address information of the user terminal 4 that is sender of the account registration request was sent. In response to this, the user management part 33 adds a new user information record 300 to the user information storage part 30, and registers the account information, the address information, and the personal information received from the account registration request processing part 36 in fields 301 to 303 of this record 300 (S401).

Then, the account registration request processing part 36 sends the account registration completion notification including the account information to the user terminal 4 which is the sender of the account registration request via the WAN interface part 29 (S402).

FIG. 18(A) is a flowchart for explaining account registration request process of the management device 3.

This flow is started when the login processing part 37 receives the login request from the user terminal 4 via the WAN interface part 29.

First, the login processing part 37 cooperates with the user management part 33 to perform login authentication by using the account information included in the login request received from the user terminal 4 (S410). In particular, the login processing part 37 requests for searching for a password along with the user ID included in the account information to the user management part 33. In response to this, the user management part 33 uses the user ID received from the login processing part 37 as a key to search the user information storage part 30 for a record 300 including this user ID. If the user management part 33 finds the corresponding record 300, the user management part 33 notifies the login processing part 37 of the password registered in this record 300, and if the user management part 33 cannot find the corresponding record 300, the user management part 33 notifies the login processing part 37 that the corresponding record does not exist. In response to this, if the password received from the user management part 33 matches the password contained in the account information of the login request, the login processing part 37 permits the login (authentication is established); if they do not match or if the user management part 33 notifies the user that the corresponding record does not exist, the login processing part 37 rejects the login (authentication is not established).

Next, if the login processing part 37 permits the login (YES in S411), the login processing part 37 updates the login status registered in the field 306 of the record 300 of the user information detected from the user information storage part 30 by using the user ID of the account information included in the login request as a key, and sends the login permission notification to the user terminal 4 that is sender of the login request via the WAN interface part 29 (S412). On the other hand, if the login processing part 37 rejects the login (NO in S411), the login processing part 37 performs a predetermined error process, such as sending a message to that effect via the WAN interface part 29 to the user terminal 4 that is sender of the login request (S413).

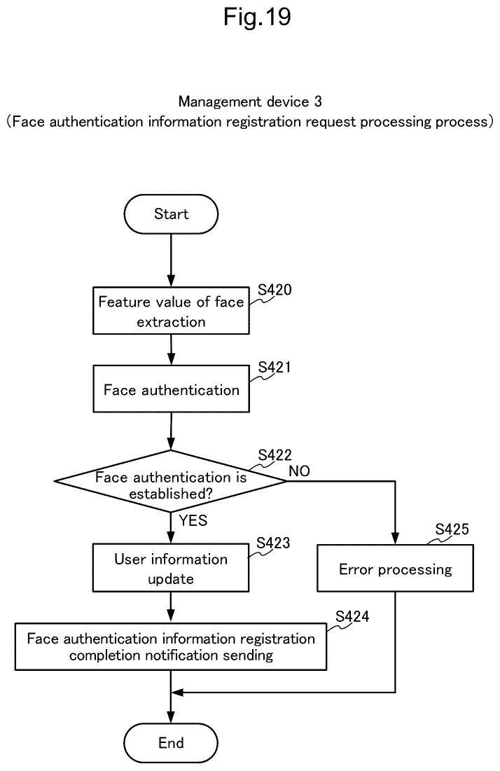

FIG. 19 is a flowchart for explaining face authentication information registration request processing process of the management device 3;

This flow is started when the face authentication information registration request processing part 38 receives the face authentication information registration request via the WAN interface part 29 from the user terminal 4 held by the user who is logged in (the user terminal 4 in which the address information of the user is stored in the field 302 in the user information storage part 30 and the user information record 300 in which the login status in the field 306 is “logged in”).

First, the face authentication information registration request processing part 38 performs image processing on the image data both of the user's face and license included in the face authentication information registration request, and extracts feature value of the face from each of the image data (S420).

Next, the face authentication information registration request processing part 38 performs face authentication processing by using the feature value of the face extracted from the image data both of the user's face and license (S421). In particular, the face recognition information registration request processing part 38 analyzes the degree of matching between the feature value of the face extracted from the image data of the user's face and the feature value of the face extracted from the image data of the license, and determines that face recognition is established if the degree of matching is equal to or greater than a predetermined value, and determines that face recognition is not established if the degree of matching is less than the predetermined value.

If face authentication is established (YES in S422), the face authentication information registration request processing part 38 passes the feature value of the face extracted from the image data of the user's face or the user's license to the user management part 33, and the user management part 33 registers the feature value of the face as face authentication information in the field 305 of the user information record 300 of the currently logged-in user registered in the user information storage part 30 (the user information record 300 in which the address information of the sender of the face authentication information registration request is registered in the field 302) (S423). Then, the face authentication information registration request processing part 38 sends the face authentication information registration completion notification to the user terminal 4 that is sender of the face authentication information registration request via the WAN interface part 29 (S424).

On the other hand, if face authentication is not established (NO in S422), the face authentication information registration request processing part 38 performs a predetermined error processing, such as sending a message to that effect to the user terminal 4 that is sender of the face authentication information registration request via the WAN interface part 29 (S425).

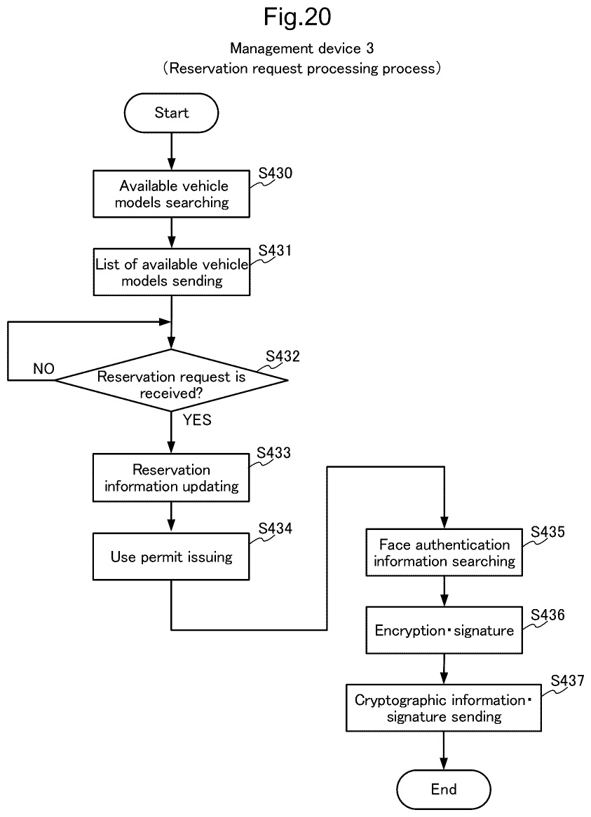

FIG. 20 is a flowchart for explaining reservation request processing process of the management device 3.

This flow is started when the reservation processing part 39 receives the browsing request from the user terminal 4 held by the user who is logged in via the WAN interface part 29.

First, the reservation processing part 39 notifies the reservation management part 35 of the date and time of use (start date and time of use and end date and time of use) included in the browsing request and instructs the reservation management part 35 to search for available vehicle models. In response to this, the reservation management part 35 refers to the reservation information storage part 32 to search for available vehicle models in the time period of the date and time of use (the time period from the start date and time of use to the end date and time of use) (S430). In particular, the reservation management part 35 searches the reservation information table 320 of the vehicles 5 that are not reserved for the time slot of the date and time of use from the reservation information storage part 32. Then, the reservation management part 35 identifies the vehicle model 323 included in the vehicle information 321 in association with the searched table 320 as an available vehicle model.

Next, the reservation management part 35 notifies the reservation processing part 39 of the list of available vehicle models. In response to this, the reservation processing part 39 sends the list data of available vehicle models to the user terminal 4 that is sender of the browse request via the WAN interface part 29 (S431).

Next, when the reservation processing part 39 receives the reservation request from the user terminal 4 that is sender of the browsing request via the WAN interface part 29 (YES in S432), the reservation processing part 39 passes the vehicle model and the date and time of use specified in the reservation request to the reservation management part 35 and instructs the reservation of the vehicle 5. The reservation management part 35 identifies one reservation information table 320 in association with the vehicle information 321 including the vehicle model 323 that matches the passed vehicle model from among the reservation information tables 320 searched in S430. Then, the reservation management part 35 adds a reservation for the time period of the passed date and time of use (the time period from the start date and time of use to the end date and time of use) to the identified reservation information table 320, and updates the reservation information (S433). If the reservation for the time period of the passed date and time of use has already been registered after S430, the reservation management part 35 identifies one of the reservation information tables 320 searched for in S430 that is association with the vehicle information 321 including the vehicle model 323 matching the passed vehicle model, and updates the reservation information.

Then, the reservation processing part 39 issues the use permit including, as conditions on use, the date and time of use reserved by the reservation management part 35 (S434). In addition, the reservation processing part 39 notifies the user management part 33 of the address information of the user terminal 4 that is sender of the reservation request, and instructs the user management part 33 to obtain the face authentication information. In response to this, the user management part 33 searches the user information storage part 30 for the user information record 300 in which the address information notified by the reservation processing part 39 is registered in the field 302, and notifies the reservation processing part 39 of the face authentication information registered in the field 305 of this record 300 (S435).

Next, the reservation processing part 39 notifies the utilization control management part 34 of the vehicle number 322 of the vehicle information 321 in association with the reservation information table 320 whose reservation information was updated in S433, and instructs a search for the utilization control device information of the utilization control device 1 installed in the vehicle 5 to which this vehicle number 322 is assigned. In response to this, the utilization control device management part 34 searches the utilization control device information storage part 31 for the utilization control device information record 310 in which the notified vehicle number is registered in the field 314, and passes the searched record 310 to the reservation processing part 39.

Next, if necessary, the reservation processing part 39 adds the object ID and vehicle number registered in the fields 311, 314 of the utilization control device information record 310 received from the usage control device management part 34 to the issued usage permit, and encrypts this use permit and the face authentication information received from the user management part 33 with the common key registered in the field 312 of the utilization control device information record 310 to generate the cryptographic information. Further, the reservation processing part 39 generates the signature for this cryptographic information by using the secret key registered in the field 313 of the utilization control device information record 310 (S436).

Then, the reservation processing part 39 sends the cryptographic information and the signature to the user terminal 4 that is sender of the reservation request via the WAN interface part 29, together with the guidance information including the vehicle information 321 in association with the reservation information table 320 whose reservation information was updated in S433 (S437).

Hereinabove, one embodiment of the present invention has been described.

In this embodiment, the utilization control device 1 obtains the use permit and the face authentication information used to lift the restriction on use of the vehicle 5 that is the usage target object from the user terminal 4 by using the Near Field communication 63, and determines whether or not to lift the restriction on use of the vehicle 5 by using the obtained use permit and the face authentication information without outputting the obtained use permit and face authentication information to an external device. In addition, the use permit and face authentication information are proven their legitimacy by verifying the signature by using the public key. Therefore, security risks are reduced.

Further, in this embodiment, the door lock of the vehicle 5 and the lock of the key box 10 (first restriction on use) are lifted only when the conditions on use included in the use permit are satisfied, and if they are not satisfied, the door lock of the vehicle 5 and the lock of the key box 10 are not lifted. Therefore, the use permit that does not meet the conditions on use becomes invalid even if its validity is proven, so there is no need to have the user of the user terminal 4 return the use permit, thereby convenience is improved.

Further, in this embodiment, when the door lock of the vehicle 5 and the lock of the key box 10 (first restriction on use) are lifted, and the user sits in the driver's seat of the vehicle 5 to turn on the ignition of the vehicle 5 by using the vehicle key obtained from the key box 10, face authentication is performed by using the image data including the user's face imaged by the camera 2 and the face authentication information. Then, if face authentication is established, the engine start lock (second restriction on use) of the vehicle 5 is lifted. By this reason, even if the validity of the use permit is proven and the conditions on use included in the use permit are satisfied, if the user in the driver's seat is not a legitimate user of the user terminal 4 managed by the management device 3, the engine of the vehicle 5 cannot be started. Therefore, driving of the vehicle 5 can be restricted to only a legitimate user.

In this way, according to the present embodiment, it is possible to improve the convenience while reducing the security risk in use management of the usage target object, and further, it is possible to limit the operation of vehicle 5 to only a legitimate user.

Further, in this embodiment, by registering the license in advance, it is possible to prevent people whose licenses are not registered from driving. This makes it possible to control risk in vehicle sharing services by preventing anyone other than the person who made the reservation (i.e., someone who has pre-registered the license), such as someone who is not insured or does not have the license, from driving.

Further, in this embodiment, the user terminal 4 sends to the management device 3 the face authentication information registration request including the image data of the user's face imaged by the camera 43 and imaged data of the license. The management device 3 then extracts the feature value of the user's face from the image data of the user's face and the image data of the license included in the face authentication information registration request received from the user terminal 4, and performs face authentication. If face authentication is established, the management device 3 manages the feature value of the user's face extracted from the image data of the user's face or the image data of the license as the face authentication information of the user. Therefore, according to this embodiment, the user can register his/her own face authentication information in the management device 3 by using the user terminal 4, thereby improving convenience. In this embodiment, the license is used for face authentication when registering the face authentication information of the user, but it is not limited to the license. A photo ID that can be used as an identification card (for example, a photo document such as a passport issued by a government agency, etc.) may also be used.

In addition, in this embodiment, the management device 3 encrypts the use permit and the face authentication information for the utilization control device 1 by using the common key associated with this utilization control device 1 to generate the cryptographic information, and generates the signature for the cryptographic information by using the secret key associated with this utilization control device 1 to send the cryptographic information and the signature to the user terminal 4. Then, the utilization control device 1 verifies the signature received from the user terminal 4 together with the cryptographic information by using the public key set in the utilization control device 1 its self. And if the signature verification is established, the utilization control device 1 decrypts the cryptographic information into the use permit and the face authentication information by using the common key set in the utilization control device 1 its self. Therefore, according to this embodiment, it is possible to further strengthen the security of the use permit and the face authentication information.

The present invention is not limited to the above embodiment, and can be changed variously within the scope of the invention.

For example, in the above embodiment, the management device 3 is provided with the reservation information storage part 32, the reservation management part 35, and the reservation processing part 39 to process the reservation request for the vehicle 5. However, the present invention is not limited to this. A reservation server having the reservation information storage part 32, the reservation management part 35, and the reservation processing part 39 may be provided separately from the management device 3, and this reservation server may be made to process the reservation request for the vehicle 5. Namely, the reservation server receives the browsing request from the user terminal 4 and sends to the user terminal 4 the list of available vehicle models for the date and time of use specified in the browsing request. When, the reservation server receives the reservation request from the user terminal 4, the reservation server specifies the vehicle 5 that is the vehicle model included in the reservation request and is available at the date and time of use included in the reservation request. Then, the reservation server notifies to the management device 3 the vehicle 5 and the date and time of use together with the address information of the user terminal 4 that made the reservation request. In response to this, the management device 3 issues the use permit including the date and time of use notified by the reservation server as the conditions on use, and generates the signature for the cryptographic information of the use permit and the face authentication information in association with the user of the user terminal 4 that made the reservation request by using the secret key in association with the utilization control device 1 installed in the vehicle 5 notified by the reservation server. Then, the management device 3 sends the cryptographic information and the signature to the user terminal 4 that made the reservation request. In this case, the reservation information storage part 32, the reservation management part 35, and the reservation processing part 39 can be omitted from the management device 3.

Further, in the above embodiment, the management device 3 uses the common key secretly shared between the management device 3 and the usage control device 1 to encrypt the use permit and the face authentication information to be sent to the user terminal 4, and the utilization control device 1 decrypts the cryptographic information received from the user terminal 4 into the use permit and the face authentication information by using this common key. However, the present invention is not limited to this. The use permit and the face authentication information may be sent from the management device 3 to the utilization control device 1 via the user terminal 4 in plain text, without being encrypted.

Further, in the above embodiment, the management device 3 generates the signature for the use permit and the face authentication information by using the secret key paired with the public key set in the utilization control device 1. However, the present invention is not limited to this. The management device 3 may generate the signature for the use permit or a part of it by using the secret key paired with the public key set in the utilization control device 1.

Further, in the above embodiment, the key box 10 may be incorporated in the utilization control device 1 in advance, or may be externally attached to the utilization control device 1 later.

Further, in the above embodiment, it is assumed that the ignition of the vehicle 5 is turned on by using the vehicle key (by inserting the vehicle key into the key cylinder). However, the present invention is not limited to this. The vehicle 5 may be one in which the ignition can be turned on by operating an ignition button, provided that the vehicle key is inside the vehicle or in the vicinity of the vehicle 5. In this case, since there is no need to take the vehicle key out of the key box 10, the utilization control device 1 may keep the key box 10 locked even if the conditions on use included in the use permit are satisfied. In addition, the vehicle 5 may be of a so-called keyless type. In this case, the key box 10 can be omitted.

Further, in the above embodiment, when the door lock (first restriction on use) of the vehicle 5 is lifted and the user sits in the driver's seat of the vehicle 5 to turn on the ignition of the vehicle 5, the utilization control device 1 performs face authentication by using the image data including the image of the user's face imaged by the camera 2 and the face authentication information obtained together with the use permit by decrypting the cryptographic information received from the user terminal 4 together with the signature. Then, when face authentication is established, the engine start lock (second restriction on use) of the vehicle 5 is lifted. However, the present invention is not limited to this.

For example, instead of face authentication information, other biometric authentication information such as fingerprint authentication information or vein authentication information may be used. That is, instead of the camera 2, a biometric authentication information reader is installed near the driver's seat of the vehicle 5. When the door lock (first restriction on use) of the vehicle 5 is lifted and the user sits in the driver's seat of the vehicle 5 to turn on the ignition of the vehicle 5, the utilization control device 1 performs biometric authentication by using the user's biometric information read by the biometric information reader and the biometric authentication information obtained together with the use permit by decrypting the cryptographic information received from the user terminal 4 together with the signature. Then, if biometric authentication is established, the engine start lock (second restriction on use) of the vehicle 5 is lifted.

In this case, in S322 of the flow shown in FIG. 12 (A), the user terminal 4 sends the biometric information read by the biometric information reader equipped in the user terminal 4 to the management device 3, together with the image data of the user's face obtained in S320 and the image data of the license obtained in S321. Then, in S423 of the flow shown in FIG. 19, the management device 3 registers the biometric authentication information received from the user terminal 4 in field 305 of the record 300 of the user information of the user registered in the user information storage part 300 in place of the face authentication information. In addition, in S435 to S437 of the flow shown in FIG. 20, the management device 3 searches for the user information record 300 300 of the user from the user information storage part 300, and encrypts the biometric authentication information registered in the field 305 of this record 300 and the use permit issued in S434, to generate the signature for this cryptographic information, and sends the cryptographic information and the signature to the user terminal 4.

Further, in the above embodiment, when the management device 3 issues the use permit (S434 of the flow shown in FIG. 20), the use permit may include the personal information of the user registered in the field 303 of the user information record 300 of the user registered in the user information storage part 300, and a list of personal information of persons permitted to drive the vehicle 5 may be pre-registered in the utilization control device 1. If the personal information included in the use permit is not pre-registered in the utilization control device 1, the engine start lock (second restriction on use) of the vehicle 5 may not be lifted regardless of whether the above-mentioned face authentication/biometric authentication is established or not.

Further, in the above embodiment, an alcohol detection sensor may be installed near the driver's seat of vehicle 5, and if this alcohol detection sensor detects a predetermined amount of alcohol or more from the user seated in the driver's seat, the engine start lock (second restriction on use) of vehicle 5 may not be lifted regardless of whether the above-mentioned face authentication/biometric authentication is established or not.

Further, in the above embodiment, when the management device 3 issues the use permit (S434 in the flow shown in FIG. 20), the license data (e.g., license number) registered in the field 304 of the user information record 300 of the user registered in the user information storage part 300 is used as a search key to obtain the user's insurance information or accident history information from an insurance information database that manages the licensee's insurance information or an accident history information database that manages the licensee's accident history information, which are connected to WAN 60 to include the information in the use permit. In addition, the insurance contract details or accident history details of the person permitted to drive the vehicle 5 are pre-registered in the utilization control device 1. If the insurance information or accident history information included in the use permit does not satisfy the insurance contract details or accident history details pre-registered in the utilization control device 1, the engine start lock (second restriction on use) of the vehicle 5 may not be lifted regardless of whether the above-mentioned face authentication/biometric authentication is established or not.

Here, the above-mentioned face authentication/biometric authentication may be omitted in the case of determining whether the personal information included in the use permit is included in the list of personal information registered in the utilization control device 1, the case of determining whether the alcohol detection sensor is detected the predetermined amount of alcohol or more in the user seated in the driver's seat, and the case of determining whether the insurance information or accident history information included in the use permit satisfies the contract details of the insurance or accident history details pre-registered in the usage control device 1.

Namely, the utilization control device 1 may lift the engine start lock (second restriction on use) of the vehicle 5, if the personal information included in the use permit is included in the list of personal information registered in the utilization control device 1, if the alcohol detection sensor does not detect the predetermined amount of alcohol in the user sitting in the driver's seat, and if the insurance information or accident history information included in the use permit satisfies the contract details of the insurance or the accident history details pre-registered in the utilization control device 1.

Further, in the above embodiment, the management device 3 includes the user information storage part 30, the utilization control device information storage part 31, and the reservation information storage part 32. However, the present invention is not limited to this. These storage parts 30-32 may be held by a file server connected with the WAN 60. In this case, the user information storage part 30, the utilization control device information storage part 31, and the reservation information storage part 32 may be held by respective different file servers. Or, each storage part may be divided into a plurality of parts held by a plurality of file servers in a distributed manner. Further, it is favorable that the block-chain technology or the like is used to ensure validity of information stored in these storage parts 30-32.

Further, in the above embodiment, an example has been described in which the utilization control device 1 is used to lift restrictions on use (door lock, lock on the key box 10, and lock on engine start) on the vehicle 5 having the door lock mechanism. However, the present invention is not limited to this. The utilization control device 1 may be used to lift restrictions on use of a vehicle (motorcycle, bicycle, etc.) having a locking mechanism instead of a door lock mechanism, or the utilization control device 1 may be used to lift restrictions on use of a moving body other than the vehicle 5, such as a ship.

Alternatively, the utilization control device 1 may be used to remove restriction on use (such as a lock entrance, lock on activation of equipment installed in a facility, etc.) for facilities such as a hotel, an inn, a private lodging facility, a house, a warehouse, etc. that are the usage target object. Namely, when the verification of the signature received from the user terminal 4 together with the use permit and the face authentication information is established and the conditions on use included in the use permit are satisfied, the utilization control device 1 unlocks the entrance of the facility. And further, when the entrance of the facility is unlocked, face authentication by using the image data including the face image of the user imaged by the imaging device and the face authentication information it performed, and if face authentication is established, the utilization control device 1 unlocks the startup lock of the equipment installed in the facility.

Alternatively, the usage target object may be a terminal for browsing electronic media such as electronic medical records and electronic books, and the utilization control device 1 may be used to lift restrictions on use (access lock, write lock) on this usage target object. Namly, when verification of the signature received from the user terminal 4 together with the use permit and the face authentication information is established, and the conditions on use included in the use permit are satisfied, the utilization control device 1 lifts the access lock to the file by the browsing terminal, etc. And further, when the access lock to the file by the browsing terminal, etc. is lifted, face authentication is performed by using the image data including the face image of the user imaged by the imaging device and the face authentication information, and when face authentication is established, the writing lock to the file by the browsing terminal, etc. is lifted.

Further, the present invention is not limited to these examples, but can be widely used in general use management technologies that require confirmation of the person who reserves a usage target object and the person who actually uses the reserved usage target object. In addition, the present invention can also be widely used in general use management technologies that require matching a personal certificate with an image (such as an ID card) with the person using the usage target object.

Further, in the above embodiment, the case where the date and time of use (the start date and time of use and the end date and time of use) is used as the conditions on use included in the use permit has been described as an example. However, the present invention is not limited to this. The conditions on use included in the use permit may be any conditions that define the conditions for lifting the restriction on use of the usage target object. For example, the number of uses may be included instead of or in addition to the date and time of use. In this case, the utilization control device 1 may determine whether the conditions on use are satisfied by managing the number of uses of the use permit for each use permit.

### REFERENCE SIGNS LIST

1: utilization control device; 2: camera; 3: management device; 4: user terminal; 5: vehicle; 10: key box; 11: Near Field Communication part; 12: in-vehicle network connection part; 13: hole data storage part; 14: restriction on use lifting request receiving; 15: signature verification part; 16: decryption part; 17: image data obtaining part; 18: feature value extraction part; 19: face authentication part; 20: restriction on use lifting part; 29: WAN interface part; 30: use information storage part; 31: utilization control device information storage part; 32: reservation information storage part; 33: user management part; 34: utilization control device management part; 35: reservation management part; 36: account request processing part; 37: logion processing part; 38: face authentication information registration request processing part; 39: reservation processing part; 40: man-machine interface part; 41: wireless network interface part; 42: Near Field Communication part; 43: camera; 44: account information storage part; 45: cryptographic information storage part; 46: account registration requesting part; 47: login requesting part; 48: face authentication information registration requesting part; 49: reservation requesting part; 50: restriction on use lift requesting part; 60: WAN; 61: relay device; 62: wireless network; 63: Near Field Communication

1-8. (canceled)

9. A utilization management system for managing use of a usage target object, comprising:
a utilization control device that controls use of the usage target object by locking/unlocking, startup control, access control, or encrypting/decrypting based on a use permit including conditions on use of the usage target object;
an imaging device that images a face of a user of the usage target object and sends the image data to the utilization control device;
a management device that manages the utilization control device in association with the usage target object; and
a user terminal that communicates the use permit to the utilization control device, wherein,
the management device comprises:
a key management means that manages a secret key paired with a public key set in the utilization control device, in association with the utilization control device concerned;
a face authentication information management means that manages face authentication information of the user; and
a use permit sending means that generates a signature on the use permit by using the secret key managed by the key management means, to send the use permit, the face authentication information and the signature to the user terminal,
the user terminal comprises:
a restriction on use lift request means that sends restriction on use lift request including the use permit, the face authentication information and the signature received from the management device to the utilization control device via Near Field Communication, and
the utilization control device comprises:
a signature verification means that verifies the signature included in the restriction on use lift request received from the user terminal via the Near Field Communication, by using the public key set in the utilization control device itself;
a first restriction on use lifting means that lifts first restriction on use of the usage target object when the verification is established by the signature verification means and conditions on use included in the use permit are satisfied;
a face authentication means that performs face authentication using the image data received from the imaging device and the face authentication information included in the restriction on use lift request, when the first restriction on use of the usage target object is lifted by the first restriction on use lifting means; and
a second restriction on use lifting means that lifts second restriction on use of the usage target object, when the face authentication is established by the face authentication means.

10. A utilization management system according to claim 9, wherein,
the user terminal further comprises a face authentication information registration requesting means that sends a face authentication information registration request including image data of the user's face and image data of a photo ID both imaged by a built-in or external imaging device to the management device,
the management device further comprises a face authentication means that extracts feature value of a face from the image data of the user's face included in the face authentication information registration request received from the user terminal and the image data of the photo ID to perform face authentication,
when face authentication by the face authentication means is established, the face authentication information management means manages feature value of the face extracted from the image data of the user's face or the image data of the photo ID as the face authentication information of the user.

11. A utilization management system according to claim 9, wherein,
in the management device,
the key management means also manages a common key set in the utilization control device in association with the utilization control device concerned,
the use permit sending means encrypts the use permit and the face authentication information by using the common key managed by the key management means to generate cryptographic information, and generates the signature for the cryptographic information by using the secret key managed by the key management means to send the cryptographic information and the signature to the user terminal,
wherein, in the user terminal,
the restriction on use lift request means sends the restriction on use lift request including the cryptographic information and the signature received from the management device, to the utilization control device via Near Field Communication;
wherein, in the utilization control device,
the signature verification means verifies the signature included in the restriction on use lift request received from the user terminal with the public key set in own device, and decrypts the cryptographic information included in the restriction on use lift request into the use permit and the face authentication information by using the common key set in own device if the verification is established.

12. A utilization control device for controlling use of a usage target object by locking/unlocking, startup control, access control, or encrypting/decrypting based on a use permit that includes conditions on use of the usage target object, comprising:
a signature verification means that verifies a signature included in a restriction on use lift request received from a user terminal via Near Field Communication, by using a public key set in the utilization control device itself;
a first restriction on use lifting means that lifts first restriction on use of the usage target object when the verification is established by the signature verification means and conditions on use included in the use permit are satisfied;
a face authentication means that performs face authentication using image data received from an imaging device and face authentication information included in the restriction on use lift request, when the first restriction on use of the usage target object is lifted by the first restriction on use lifting means; and
a second restriction on use lifting means that lifts second restriction on use of the usage target object, when the face authentication is established by the face authentication means.

13. A management device for managing a utilization control device that controls the use of a usage target object by locking/unlocking, startup control, access control, or encrypting/decrypting based on a use permit that includes conditions on use of the usage target object, comprising:
a key management means that manages a secret key paired with a public key set in the utilization control device, in association with the utilization control device concerned;
a face authentication information management means that manages face authentication information of a user; and
a use permit sending means that generates a signature on the use permit by using the secret key managed by the key management means, to send the use permit, the face authentication information and the signature to a user terminal that notifies via Near Field Communication to the utilization control device.

14. A utilization management method for managing use of a usage target object, by using: a utilization control device that controls use of the usage target object by locking/unlocking, startup control, access control, or encrypting/decrypting based on a use permit that includes conditions on use of the usage target object; an imaging device that images a user of the usage target object; a management device that manages the utilization control device in association with the usage target object; and a user terminal that notifies the use permit to the utilization control device, wherein,
the management device:
manages a secret key paired with a public key set in the utilization control device in association with the utilization control device concerned and manages face authentication information of the user;
generates a signature on the use permit by using the secret; and
sends the use permit, the face authentication information and the signature to the user terminal,
wherein, the user terminal:
sends a restriction on use lift request including the use permit, the face authentication information and the signature received from the management device to the utilization control device via Near Field Communication;
the imaging device:
sends image data including an image of the user's face to the utilization control device;
the utilization control device:
verifies the signature included in the restriction on use lift request received from the user terminal via the Near Field Communication, by using the public key set in the utilization control device itself;
lifts first restriction on use of the usage target object when the verification is established and conditions on use included in the use permit are satisfied;
performs face authentication using the image data received from the imaging device and the face authentication information included in the restriction on use lift request, when the first restriction on use of the usage target object is lifted; and
lifts second restriction on use of the usage target object, when the face authentication is established.

15. A program for making a computer function as a utilization control device for controlling use of a usage target object by locking/unlocking, startup control, access control, or encrypting/decrypting based on a use permit that includes conditions on use of the usage target object, wherein,
the program makes the computer function as:
a signature verification means that verifies a signature included in a restriction on use lift request received from a user terminal via Near Field Communication, by using a public key set in the computer;
a first restriction on use lifting means that lifts first restriction on use of the usage target object when the verification is established by the signature verification means and conditions on use included in the use permit are satisfied;
a face authentication means that performs face authentication using image data received from an imaging device and face authentication information included in the restriction on use lift request, when the first restriction on use of the usage target object is lifted by the first restriction on use lifting means; and
a second restriction on use lifting means that lifts second restriction on use of the usage target object, when the face authentication is established by the face authentication means.

16. A program for making a computer function as a management device that controls the use of a usage target object by locking/unlocking, startup control, access control, or encrypting/decrypting based on a use permit that includes conditions on use of the usage target object,
the program makes the computer function as:
a key management means that manages a secret key paired with a public key set in the utilization control device, in association with the utilization control device concerned;
a face authentication information management means that manages face authentication information of a user; and
a use permit sending means that generates a signature on the use permit by using the secret key managed by the key management means, to send the use permit, the face authentication information and the signature to a user terminal that notifies via Near Field Communication to the utilization control device.

17. A utilization management system according to claim 10, wherein,
in the management device,
the key management means also manages a common key set in the utilization control device in association with the utilization control device concerned,
the use permit sending means encrypts the use permit and the face authentication information by using the common key managed by the key management means to generate cryptographic information, and generates the signature for the cryptographic information by using the secret key managed by the key management means to send the cryptographic information and the signature to the user terminal,
wherein, in the user terminal,
the restriction on use lift request means sends the restriction on use lift request including the cryptographic information and the signature received from the management device, to the utilization control device via Near Field Communication;
wherein, in the utilization control device,
the signature verification means verifies the signature included in the restriction on use lift request received from the user terminal with the public key set in own device, and decrypts the cryptographic information included in the restriction on use lift request into the use permit and the face authentication information by using the common key set in own device if the verification is established.
